(19) United States
(12) Patent Application Publication
(10) Pub. No.: US 2026/0008329 A1
(43) Pub. Date: Jan. 8, 2026

(54) HOUSING ARRANGEMENT FOR A DRIVE DEVICE

(71) Applicant: ZF Friedrichshafen AG, Friedrichshafen (DE)

(72) Inventors: Hermann Lanz, Frickingen (DE); Sylva Rother, Kressbronn am Bodensee (DE); Mario Holder, Tettnang (DE); Berthold Schraff, Friedrichshafen (DE); Frank Sauter, Meckenbeuren (DE); Horst Leichsenring, Meinheim (DE)

(73) Assignee: ZF Friedrichshafen AG, Friedrichshafen (DE)

(21) Appl. No.: 19/261,094

(22) Filed: Jul. 7, 2025

(30) Foreign Application Priority Data
Jul. 8, 2024 (DE) 10 2024 206 401.7

(51) Int. Cl. B60K 1/02; B60K 1/00; B60K 17/02

(52) U.S. Cl. CPC B60K 1/02; B60K 17/02; B60K 2001/006

(57) ABSTRACT

A housing arrangement has a first and second housings. The first housing has a connection section on an outer periphery for receiving an electrical connector and a plurality of first fastening sections spaced apart evenly from each other in the peripheral direction for fastening to a second housing. The second housing has a plurality of fastening sections spaced evenly apart from each other in the peripheral direction. The first fastening sections of the first and second housings are arranged in such a way that the first housing can be fastened to the second housing in different angular positions in the peripheral direction. The first housing has at least one transmission section which is formed to correspond to one of the angular positions on a plurality of base sections, where the base sections are designed to form the transmission section corresponding to each of the angular positions.

### RELATED APPLICATIONS

This application claims the benefit of and right of priority under 35 U.S.C. § 119 to German Patent Application no. 10 2024 206 401.7, filed on 8 Jul. 2024, the contents of which are incorporated herein by reference in its entirety.

### TECHNICAL FIELD

The present invention relates to a housing arrangement for a drive device, to a drive device for a vehicle, and to a vehicle with a drive device.

### BACKGROUND

Housing arrangements for a drive device for vehicles are known. Housing arrangements can be designed to suit a specific installation space in a vehicle. However, the housing arrangements are then difficult to integrate into other vehicles with a different installation space situation.

### SUMMARY

The present invention provides an improved housing arrangement that has a small installation space and can be flexibly adapted to existing installation space situations in different vehicles

The task is solved by a housing arrangement as disclosed herein. Advantageous further developments will be apparent in light of the present disclosure.

In a first aspect, a housing arrangement for a drive device comprises a first housing and a second housing. The drive device can be designed for an electric vehicle or a hybrid vehicle. The first housing extends in the axial direction. The first housing has a connection section on an outer periphery in a radial direction for receiving an electrical connector. The first housing has a plurality of first fastening sections spaced evenly apart from each other on a first side in the axial direction for fastening to the second housing. The second housing extends in the axial direction. The second housing has a plurality of fastening sections spaced evenly apart from each other in the peripheral direction for fastening to the first housing. The first fastening sections of the first housing and the fastening sections of the second housing are arranged relative to each other in such a way that the first housing can be fastened to the second housing at different angular positions in the peripheral direction. The first housing has at least one transmission section which is formed corresponding to one of the angular positions on one of a number of base sections, wherein the number of base sections is designed to form the transmission section corresponding to each of the angular positions. This improves the compatibility of the housing arrangement for different installation situations in different vehicles. This makes the housing arrangement extremely versatile.

If two elements are fastened to each other, they are directly or indirectly coupled in such a way that movement of one element causes essentially the same movement in the other element. For example, fastening can be provided by a form-fitting or friction-fitting connection, such as a screw connection or clamp connection. Additional elements, such as transmission elements, spacer elements, or the like, may be provided between the elements.

The first housing can be fastened to the second housing in a reference alignment. The reference alignment may be an alignment of the first housing in which the electrical connector is aligned upward in a gravity direction. The direction of gravity may be formed by the direction of gravity for which the housing arrangement is installed in a vehicle positioned on a level surface without any inclination. The reference alignment can be set to vertical alignment.

The housing arrangement may be suitable for use in a drive device for a vehicle. The vehicle can be designed as an electric vehicle or a hybrid vehicle. The vehicle can be designed as a commercial vehicle, such as a truck. The vehicle may have a vehicle frame, for example a ladder frame. The vehicle may have the drive device. The housing arrangement can be designed for positioning in the vehicle.

The drive device may comprise a manual gearbox, for example a multi-speed gearbox. The manual gearbox may have an input element, such as an input shaft. The input element can be aligned in the axial direction. The input element can form a pivot point. The axis of rotation can be aligned in the axial direction. The radial direction can be aligned relative to the axial direction. The peripheral direction can be directed around the axis of rotation. The manual gearbox can be arranged within the second housing.

The drive device may comprise a first drive motor. The first drive motor can be arranged within the first housing. The first drive unit may comprise an electric motor. The electric motor can be designed as a permanently excited electric motor. The first drive motor can be arranged coaxially with the input element. The electrical connector can be set up to supply electrical power to the first drive motor.

The drive device may comprise a transmission gearbox, for example a reduction gearbox for reducing a drive speed of the first drive machine. The transmission gearbox can be arranged in the radial direction within the first drive machine. The transmission gearbox can be arranged in the axial direction in the same plane as the first drive machine. The first drive engine can be mechanically connected to the input element of the manual gearbox, for example via the transmission gearbox.

If two elements are mechanically connected, they are directly or indirectly coupled in such a way that movement of one element causes a reaction in the other element. For example, a mechanical connection can be provided by a form-fitting or friction-locking connection. The mechanical connection can correspond to the combing of corresponding teeth on the two elements. Additional elements, such as one or more spur gear stages, may be provided between the elements. A permanently rotationally fixed connection between two elements, on the other hand, is understood to be a connection in which the two elements are rigidly coupled to each other in all intended states of the gearbox. The elements can be individual components connected to each other in a rotationally fixed manner or can also be made in one piece. A rotating connection between two elements can be selectively established or broken via a switching element, such as a clutch or brake.

The drive device may include a clutch device. The clutch device may be arranged coaxially with the input element. The clutch device may comprise a single-disc clutch or a double-disc clutch. The clutch device may comprise a double clutch module or a torque converter clutch. The clutch device may comprise a clutch actuating device, for example an electrical, mechanical, hydraulic, or pneumatic clutch actuating device. The clutch actuating device may be arranged within the first housing. The clutch device can be arranged offset in the axial direction relative to the first drive machine, for example offset to the second side. The drive device may have a second drive motor. The second drive engine comprises an internal combustion engine. The second drive motor can be mechanically connected to the input element of the manual gearbox via the clutch device.

The first housing may have a clutch compartment. The clutch actuating device can be arranged in the clutch compartment. The first housing may have a drive compartment. The first drive machine can be arranged in the drive compartment. The transmission gearbox can be arranged in the drive compartment. The drive compartment can be separated from the clutch compartment by a partition wall in the first housing. The drive compartment can be offset in the axial direction relative to the clutch compartment. The drive compartment can be arranged on the first side in the axial direction relative to the partition wall. The clutch compartment can be arranged relative to the partition wall on a second side, in the axial direction opposite to the first side. The drive compartment can form an oil compartment. The oil in the drive compartment can be used to cool the first drive motor and lubricate the transmission gearbox. The clutch compartment can form an air compartment.

The connection section for the electrical connector may comprise an electrical interface, a cable guide, or the like. The electrical connector can be designed as a plug, for example with a hinged fastening mechanism. The connection section may have a receiving section for the electrical connector. The receiving section may have a flat surface. The flat surface can extend tangentially to the peripheral direction. The connection section may have a fastening section, for example a screw connection section. The screw connection section can be designed for a plurality of screw connections, for example four or five. The connection section can extend in the radial direction from an outer side of the first housing to an inner side of the first housing.

The first housing may have twelve of the first fastening sections of the first housing. The first fastening sections of the first housing can each be designed as screw connection sections. A screw connection section may comprise at least one of a through hole, a threaded hole, and a screw. Each of these screw connection sections can be aligned in the axial direction. The first fastening sections of the first housing can be arranged at equal intervals from each other in the peripheral direction. Relative to the axis of rotation, the first fastening sections can form an angle of 30° with each other. The first fastening sections of the first housing can be arranged in the radial direction on the same periphery, for example a diameter. The first fastening sections can be arranged radially symmetrically. The first fastening sections can be arranged on an outer periphery of the first housing.

The second housing may have twelve of the fastening sections of the second housing. The fastening sections of the second housing can each be designed as screw connection sections. A screw connection section may comprise at least one of a threaded bore, a through bore, and a screw. The fastening sections of the second housing can be arranged in the radial direction and the peripheral direction so as to coincide with at least some of the first fastening sections of the first housing. The fastening sections of the second housing can be designed as an SAE1 flange in accordance with DIN ISO 7649. The fastening sections can be arranged on an outer periphery of the second housing. As a result, the first housing can optionally be fastened in the reference alignment, rotated by 30° in one direction, for example clockwise, of the peripheral direction or rotated by 30° in another direction, for example counterclockwise, of the peripheral direction in relation to the reference alignment to the second housing. This allows the first housing to be fastened to the second housing at three different angular positions. This makes the housing arrangement flexible for use in different installation situations in a vehicle.

The first housing and the second housing may each have contact surfaces via which the first housing rests against the second housing when the first housing is fastened to the second housing. One of the contact surfaces of the first housing and the second housing may be aligned in the peripheral direction. The first housing can be positioned in the axial direction relative to the second housing via the contact surfaces. One of the contact surfaces of the first housing and the second housing may protrude in the axial direction and may, for example, be designed as a key. The first housing can be positioned relative to the second housing via the contact surfaces in at least one of the peripheral and radial directions. The first housing can be arranged on the second side relative to the second housing.

A transmission section can be designed as a fluid transmission section. A transmission section may be provided for transferring a fluid, such as oil, water, or air, from an interior of the first housing, such as the drive compartment or the clutch compartment, to an exterior of the first housing or an interior of the second housing. The first housing may have several transmission sections. A transmission section can be designed to suck oil out of the drive compartment and be arranged at the bottom in the direction of gravity. The transmission section can then be designed to transfer oil from the drive compartment to, for example, an outside or the clutch compartment. A transmission section can be designed as a vent for the first housing, for example the drive compartment, and be arranged at the top in the direction of gravity. The transmission section can then be designed to transfer air from the first housing or the drive compartment to, for example, an outside or the clutch compartment. A transmission section may be provided for transferring compressed air, for example for operating the clutch device, and may, for example, be adjacent to a section of the second housing.

The first housing can have one or more, for example three or five, base sections for each transmission section. A base section can, for example, be formed from a raw part of the first housing. A transmission section can be formed on or in a base section by mechanical processing. Each of the base sections can be arranged relative to one of the angular positions. If, for example, the first housing is fastened to the second housing in the reference alignment, the respective transmission section can be designed in the respective base section for the reference alignment. If, for example, the first housing is fastened to the second housing rotated by 30°, the respective transmission section can be designed in the respective base section, which is arranged rotated by 30° to the reference alignment. If the first housing is set up for fastening to the second housing in three different angular positions, the first housing can have three base sections for each transmission section, which can, for example, be arranged at an angle of 30° to each other in the peripheral direction relative to the axis of rotation. A base section can be designed to provide a transmission section for multiple angular positions, for example via a raw part material extending in the peripheral direction. Base sections can overlap each other.

In one embodiment of the housing arrangement, the first housing may have at least twelve first fastening sections, and the second housing may have at least twelve fastening sections. This allows the first housing to be fastened to the second housing at three angular positions, for example, −30°, 0°, and 30° in the peripheral direction relative to the reference alignment.

In one embodiment of the housing arrangement, the first housing 24 may have first fastening sections. Relative to the axis of rotation, the first fastening sections may form an angle of 15° with each other. This allows the first housing to be additionally fastened to the second housing in intermediate positions. This allows five angular positions, for example, −30°, −15°, 0°, 15°, 30°, to be provided in the peripheral direction relative to the reference alignment. This makes the housing arrangement flexible for use in different installation situations in different vehicles.

An intermediate position can be rotated by 15° in one direction of the peripheral direction or by 15° in another direction of the peripheral direction relative to the reference alignment. The first housing may have base sections for the intermediate positions. If the first housing is set up for fastening to the second housing in five different angular positions, the first housing can have five base sections for each transmission section, which can be arranged, for example, at an angle of 15° to each other in the peripheral direction relative to the axis of rotation. A base section can be designed to provide a transmission section for multiple angular positions. Base sections can overlap each other.

The second housing may have additional fastening sections arranged centrally in the peripheral direction between two of the fastening sections of the second housing. One of the additional fastening sections can be arranged in the radial direction and the peripheral direction coincident with one of the first fastening sections of the first housing. The second housing may, for example, have ten or twelve additional fastening sections.

In one embodiment of the housing arrangement, the first housing may have a transmission section that is set up to transfer compressed air. The compressed air can be supplied from the second housing. The transmission section can be formed on the contact surface of the first housing. A fluid channel can open into the transmission section. The transmission section can be set up to operate the clutch device, which has, for example, a pneumatic clutch actuation device. The fluid channel can extend from the transmission section to the clutch device, for example to the clutch actuating device. The fluid channel can extend in the axial direction, for example. The transmission section may have a sealing device. The sealing device may comprise, for example, a rubber seal, an O-ring, or a paper seal. The sealing device can be arranged on the contact surface of the first housing and the contact surface of the second housing, for example, it can be in contact with them.

In one embodiment of the housing arrangement, the first housing may have a transmission section designed to suck in oil. The transmission section can be designed to suck oil from the drive compartment and be arranged at the bottom in the direction of gravity. For each angular position, the transmission section can be designed on one of the base sections so that the transmission section is arranged at the bottom in the direction of gravity.

In one embodiment of the housing arrangement, the first housing may have a transmission section that is designed as a vent for the first housing. The transmission section can be designed as ventilation for the drive compartment or clutch compartment of the first housing. The transmission section can be arranged at the top in the direction of gravity. For each angular position, the transmission section can be designed on a base section such that the transmission section is arranged at the top in the direction of gravity. The transmission section may, for example, be designed as a through-hole in the radial direction from the inside of the first housing to the outside of the first housing

In one embodiment of the housing arrangement, the housing arrangement may comprise a third housing. The third housing can be arranged opposite the second housing relative to the first housing. The third housing may have a number, for example twelve, of fastening sections spaced evenly apart from each other in the peripheral direction for fastening to the first housing. The second housing can be arranged on the first side relative to the first housing. The first housing may have a number, for example twelve, of second fastening sections on the second side, which are evenly spaced from each other in the peripheral direction, for fastening to the third housing. The second fastening sections of the first housing and the fastening sections of the third housing can be arranged relative to each other in such a way that the first housing can be fastened to the third housing in different angular positions in the peripheral direction. The third housing can be arranged on the second side relative to the first housing

The second fastening sections of the first housing can each be designed as screw connection sections. A screw connection section may comprise at least one of a through hole, a threaded hole, and a screw. Each of these screw connection sections can be aligned in the axial direction. The second fastening sections of the first housing can be arranged at equal intervals from each other in the peripheral direction. Relative to the axis of rotation, the second fastening sections can be at an angle of 30° to each other. The second fastening sections of the first housing can be arranged in the radial direction on the same periphery, for example a diameter. The second fastening sections can be arranged radially symmetrically. The second fastening sections can be arranged on an outer periphery of the first housing.

The fastening sections of the third housing can each be designed as screw connection sections A screw connection section may comprise at least one of a threaded bore, a through bore, and a screw. The fastening sections of the third housing can be arranged in the radial direction and in the peripheral direction so that they coincide with the second fastening sections of the first housing. This allows the first housing to be fastened to the third housing either in the reference alignment, rotated by 30° in one direction, or rotated by 30° in another direction relative to the reference alignment. This allows the first housing to be fastened to the third housing in three angular positions. The fastening sections of the third housing can be arranged on an outer periphery of the third housing.

The first housing may have 24 second fastening sections. Relative to the axis of rotation, the second fastening sections can form an angle of 15° with each other. This allows the first housing to be additionally fastened to the third housing in intermediate positions An intermediate position can be rotated by 15° in one direction or by 15° in another direction relative to the reference alignment. This allows the first housing to be fastened to the third housing in five angular positions. This makes the housing arrangement flexible for use in different installation situations in a vehicle.

The third housing may have additional fastening sections arranged in the peripheral direction between the fastening sections of the third housing. One of the additional fastening sections can be arranged in the radial direction and the peripheral direction coincident with one of the second fastening sections of the first housing. The third housing may, for example, have ten or twelve additional fastening sections.

In one embodiment of the housing arrangement, the first housing may be cylindrical in shape. An end section of the second housing on the second side may be cylindrical in design. The third housing can be cylindrical in design. The first housing, the end section of the second housing, and the third housing can form a cylindrical shape.

In a second aspect, a drive device comprises a housing arrangement according to one of the preceding embodiments, a first drive machine, a manual gearbox, and an electrical connector. Further features, advantages, and effects of the second aspect can be found in the first aspect. Furthermore, the characteristics, advantages, and effects of the second aspect represent characteristics, advantages, and effects for the first aspect. The drive device may be configured for use in a vehicle. The vehicle can be designed as an electric vehicle or a hybrid vehicle. The vehicle may be designed as a commercial vehicle, for example as a truck. The first drive motor is arranged inside the first housing. The manual gearbox is arranged inside the second housing. The manual gearbox has an input element that can be mechanically connected to the first drive engine. The first drive machine can be connected to the input element, for example via a transmission gearbox. The electrical connector is fastened to a connection section on an outer periphery of the first housing. The electrical connector is designed to supply electrical power to the first drive motor. The drive device may comprise the transmission gearbox. The transmission gearbox can be set up to transfer drive power from the first drive motor to the input element of the manual gearbox. The transmission gearbox can be arranged in the axial direction in the same plane as the first drive machine or completely within the first drive machine. The transmission gearbox can be arranged in the radial direction within the first drive machine.

In one embodiment of the drive device, the drive device may comprise a clutch device and a second drive machine. The second drive engine may comprise an internal combustion engine. The clutch device can be arranged at least in sections in the third housing. The clutch device can be arranged at least in sections in the first housing. The clutch device may include a clutch actuating device. The clutch actuating device can be arranged in the first housing. The second drive motor can be mechanically connected to the input element of the manual gearbox via the clutch device. The drive device can then be used for a hybrid vehicle.

In a third aspect, a vehicle has a drive device according to one of the preceding embodiments and at least one drive element that is set up to drive the vehicle via the drive device. Further features, effects, and benefits for the third aspect can be found in one of the previous aspects. Furthermore, the characteristics, effects, and advantages of the third aspect also represent characteristics, effects, and advantages for one of the preceding aspects. The vehicle can be designed as a commercial vehicle, such as a truck. The vehicle can be designed as an electric vehicle or a hybrid vehicle. The vehicle can be designed to be driven by at least one of the first drive motor and the second drive motor. The drive element can be designed as a drive wheel. The drive element can be designed as a chain drive. The vehicle may have two drive elements, for example two driven front wheels or rear wheels. The drive device can be mechanically connected to the drive element via drive shafts. The drive shafts can provide at least one of a steering angle and a vertical movement in the direction of gravity for the drive element.

### BRIEF DESCRIPTION OF THE FIGURES

FIG. 1 shows a top view of an embodiment of a drive device for a vehicle.

FIG. 2 shows a sectional view of the embodiment of the drive device.

FIG. 3 shows a top view of an embodiment of the drive device.

FIG. 4 shows a sectional view of the embodiment of the drive device.

FIG. 5 shows a top view of an embodiment of the drive device.

FIG. 6 shows a sectional view of the embodiment of the drive device.

FIG. 7 shows a top view of a schematic representation of the vehicle with the drive device.

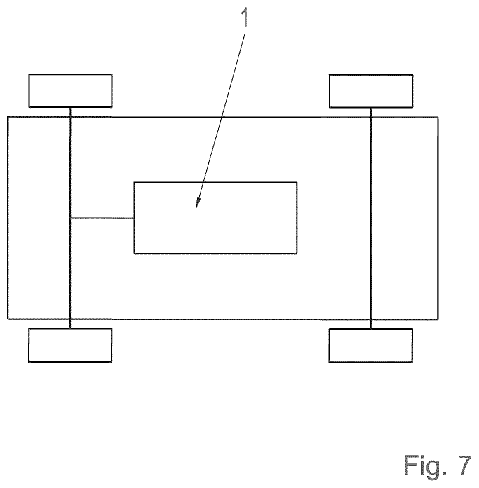

### DETAILED DESCRIPTION OF EMBODIMENTS

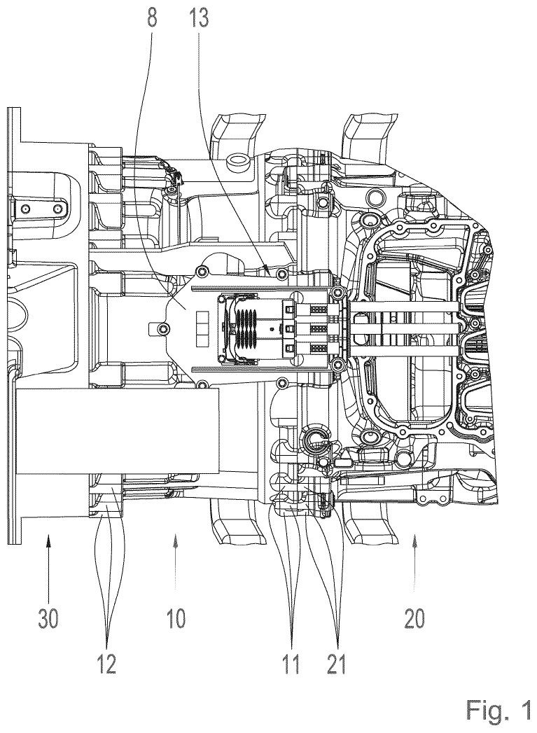

FIG. 1 shows a top view of an embodiment of a drive device 1 for a vehicle, in this case a hybrid vehicle. The housing arrangement comprises a first housing 10, a second housing 20, and a third housing 30, each of which extends in the axial direction and forms a cylindrical shape.

The first housing 10 has a connection section 13 on an outer periphery in the radial direction for receiving an electrical connector 8. The first housing 10 has, on a first side in the axial direction 24, first fastening sections 11, in this case screw connection sections, spaced apart from each other in the peripheral direction for fastening to the second housing 20. In the present case, the first fastening sections 11 form an angle of 15° in the peripheral direction with respect to the axis of rotation.

The second housing 20 has twelve fastening sections 21, in this case screw connection sections, spaced evenly apart from each other in the peripheral direction for fastening to the first housing 10. In the present case, the fastening sections 21 form an angle of 30° with each other in the peripheral direction with respect to the axis of rotation. The second housing 20 has twelve additional fastening sections, in this case screw connection sections, for fastening to the first housing 10. Each of the additional fastening sections is arranged centrally in the peripheral direction between two of the fastening sections 21 of the second housing 20. An angle with reference to the axis of rotation in the peripheral direction between one of the fastening sections 21 and one of the additional fastening sections has a value of 15°. Each of the fastening sections 21 and the additional fastening sections of the second housing 20 is arranged coaxially with one of the first fastening sections 11 of the first housing 10.

The first fastening sections 11 of the first housing 10, the fastening sections 21. and the additional fastening sections of the second housing 20 are arranged relative to each other in such a way that the first housing 10 can be fastened to the second housing 20 in different angular positions in the peripheral direction relative to a reference alignment. The reference alignment is an alignment of the first housing 10 in which the connection section 13 is arranged at the top in the direction of gravity. In this case, the first housing 10 is in the reference alignment, i.e., in an angular position with a rotation of 0° around the axis of rotation, and is fastened to the second housing 20.

The first housing 10 is designed such that at least one transmission section, in this case a vent for the first housing 10, is designed in accordance with one of the angular positions on one of a number of base sections, in this case a raw part body of the first housing 10. The transmission section is created by mechanically machining one of the base sections. This allows the first housing 10 to be fastened in five angular positions, namely −30°, −15°, 0°, 15°, and 30°, relative to the reference alignment on the second housing 20.

The first housing 10 has second fastening sections 12, in this case screw connection sections, on the second side in the axial direction 24 for fastening to the third housing 30. The second fastening sections 12 are angled at 15° to each other in the peripheral direction relative to the axis of rotation. The second fastening sections 12 are arranged coaxially with the first fastening sections 11 of the first housing 10.

The third housing 30 has fastening sections 31 on the first side in the axial direction 24, in this case screw connection sections which are not shown in FIG. 1, for fastening to the first housing 10. The fastening sections 31 of the third housing 30 are arranged coaxially with the second fastening sections 12 of the first housing 10. This means that the first housing 10 can be fastened in five angular positions, namely −30°, −15°, 0°, 15°, and 30°, relative to the reference alignment on the third housing 30. This allows the first housing 10 to be fastened in the five angular positions both to the second housing 20 and to the third housing 30.

The electrical connector 8 is designed as a plug with a hinged fastening mechanism. The electrical connector 8 is fastened to a flat receiving section of the connection section 13. Connection section 13 has an electrical interface and a cable guide. The electrical connector 8 extends outward in the radial direction. In this respect, a suitable mounting space for the electrical connector 8 must be provided in the vehicle. The electrical connector 8 is designed to supply electrical power to a first drive machine designed as an electric motor. The first drive motor is arranged in a drive compartment in the first housing 10. With a first housing 10 twisted in one of the angular positions, the mounting space is also twisted in the angular position. This allows the drive device 1 to be easily adapted to the installation space available in a vehicle.

In an alternative embodiment, the second housing 20 has ten additional fastening sections. In an alternative embodiment, the second housing 20 does not have an additional fastening section. In an alternative embodiment, the electrical connector 8 is fastened to an outer periphery of the first housing 10 via five screw connections. In a further embodiment, electrical connectors 8 are additionally fastened to an outer periphery of the second housing 20 via two screw connections.

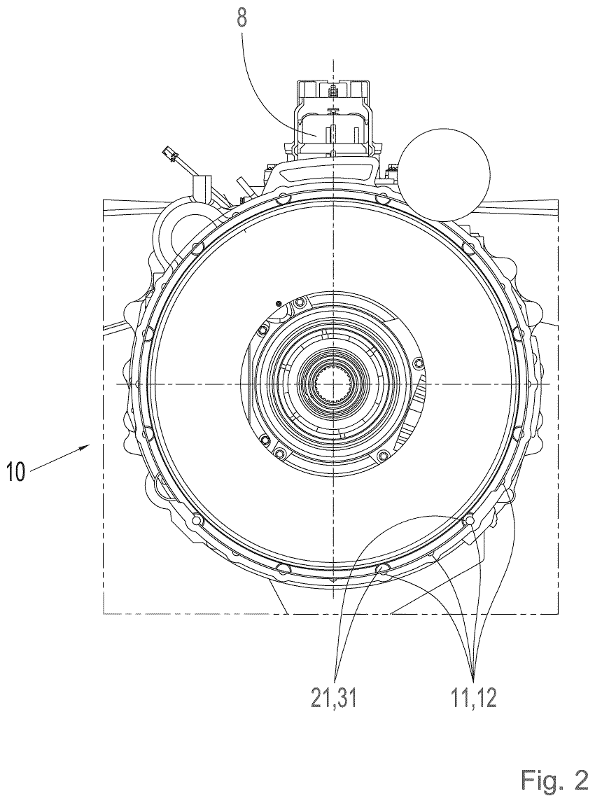

FIG. 2 shows a sectional view of the embodiment of the drive device 1. FIG. 2 shows an installation space situation in a vehicle, according to which the electrical connector 8 is arranged at the top in the direction of gravity Accordingly, the first housing 10 is fastened to the second housing 20 and to the third housing 30 in the reference alignment. One of the fastening sections 21 of the second housing 20 and one of the fastening sections 31 of the third housing 30 are each aligned with one of the first fastening sections 11 and one of the second fastening sections 12 of the first housing 10.

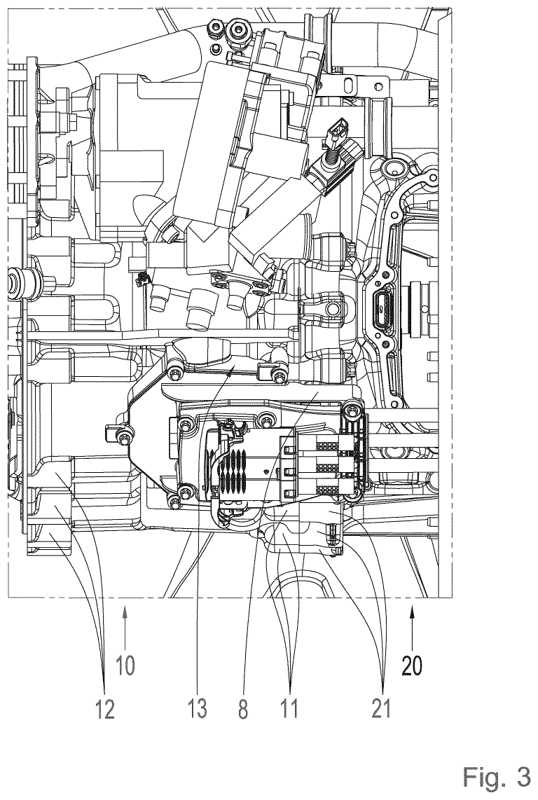

FIG. 3 shows a top view of an embodiment of the drive device 1. In the present embodiment, the first housing 10 is rotated 30° clockwise relative to the reference alignment on the second housing 20 and is fastened to the third housing 30. The electrical connector 8 and the connection section 13 are arranged in a manner rotated relative to the reference alignment. The first fastening sections 11 and the second fastening sections 12 of the first housing 10 are aligned with the fastening sections 21 of the second housing 20.

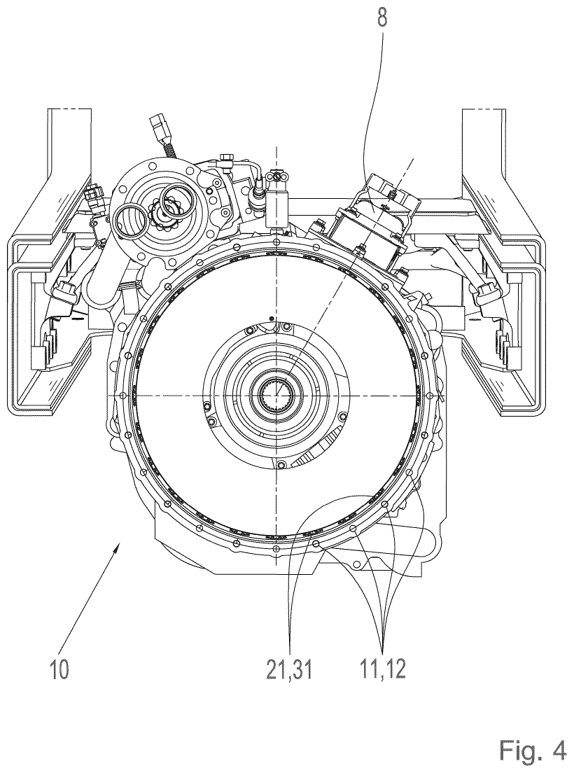

FIG. 4 shows a sectional view of the embodiment of the drive device 1. FIG. 4 shows an installation space situation in a vehicle, according to which the electrical connector 8 is rotated by 30° clockwise relative to the reference alignment. Accordingly, the first housing 10 is fastened at an angle of 30° clockwise relative to the reference alignment on the second housing 20 and on the third housing 30. One of the fastening sections 21 of the second housing 20 and one of the fastening sections 31 of the third housing 30 are each aligned with one of the first fastening sections 11 and one of the second fastening sections 12 of the first housing 10.

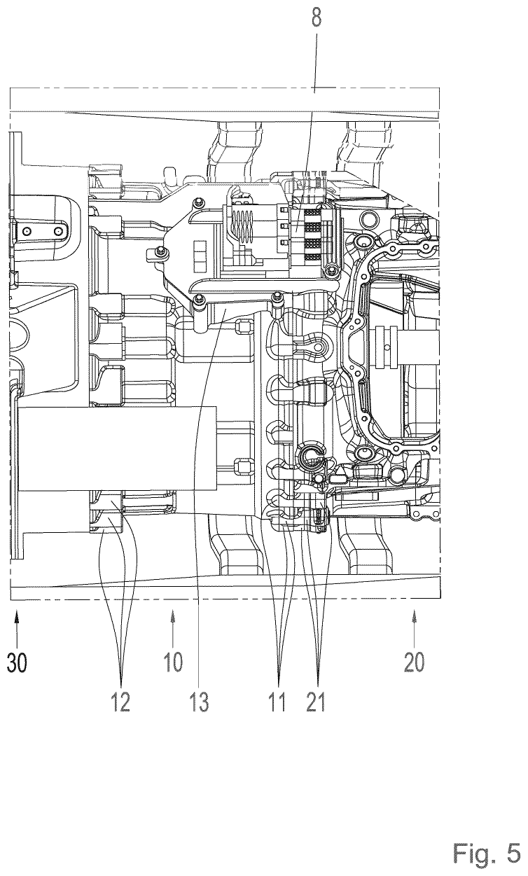

FIG. 5 shows a top view of an embodiment of the drive device 1. In the present embodiment, the first housing 10 is rotated by 30° counterclockwise, i.e., by −30°, relative to the reference alignment on the second housing 20 and is fastened to the third housing 30. The electrical connector 8 and the connection section 13 are arranged in a manner rotated relative to the reference alignment. The first fastening sections 11 and the second fastening sections 12 of the first housing 10 are aligned with the fastening sections 21 of the second housing 20.

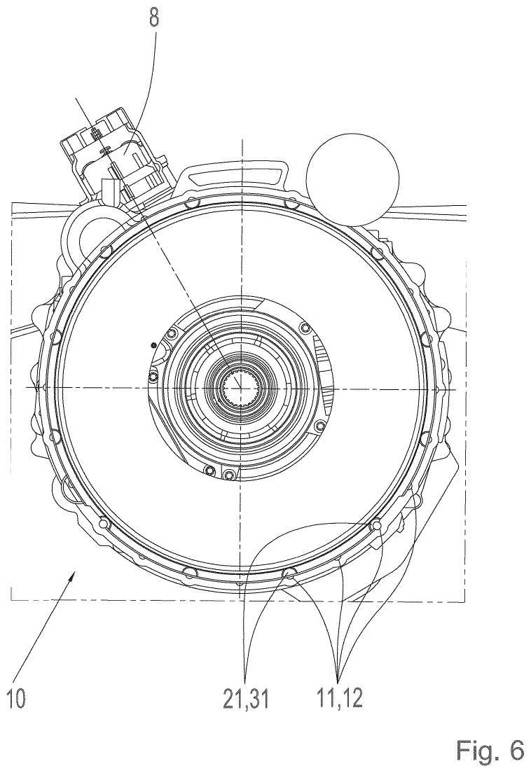

FIG. 6 shows a sectional view of the embodiment of the drive device 1. FIG. 6 shows an installation space situation in a vehicle, according to which the electrical connector 8 is rotated by 30° counterclockwise, i.e., −30°, relative to the reference alignment. Accordingly, the first housing 10 is fastened at an angle of 30° counterclockwise relative to the reference alignment on the second housing 20 and on the third housing 30. One of the fastening sections 21 of the second housing 20 and one of the fastening sections 31 of the third housing 30 are each aligned with one of the first fastening sections 11 and one of the second fastening sections 12 of the first housing 10.

FIG. 6 shows a top view of a schematic representation of the vehicle with the drive device 1. The drive device 1 is installed longitudinally in the vehicle and is mechanically connected to drive the vehicle via drive shafts with two drive elements, in this case two front tires.

### REFERENCE NUMBERS

1 Drive device
8 Electrical connector
10 First housing
11 First fastening section
12 Second fastening section
13 Connection section
20 Second housing
21 Fastening section
30 Third housing
31 Fastening sections

1. A housing arrangement for a drive device (1), wherein the housing arrangement comprises:
a first housing (10) and a second housing (20), wherein the first housing (10) extends in an axial direction, has a connection section (13) for receiving an electrical connector (8) on an outer periphery in a radial direction, and has a plurality of first fastening sections (11) evenly spaced from each other in a peripheral direction on a first side in the axial direction for fastening to a second housing(20);
wherein the second housing (20) extends in the axial direction and bas a plurality of fastening sections (21) spaced apart from each other in the peripheral direction for fastening to the first housing (10);
wherein the first fastening sections (11) of the first housing (10) and the fastening sections (21) of the second housing (20) are arranged relative to one another such that the first housing (10) can be fastened to the second housing (20) in different angular positions in the peripheral direction; and
wherein the first housing (10) bas at least one transmission section which is formed corresponding to one of the angular positions on one of a plurality of base sections. wherein the plurality of base sections is designed to form the transmission section corresponding to each of the angular positions

2. The housing arrangement according to claim 1, wherein the first housing (10) has at least twelve first fastening sections (11) and the second housing (20) has at least twelve fastening sections (21).

3. The housing arrangement according to claim 2, wherein the first housing (10) has 24 first fastening sections (11)

4. The housing arrangement according to claim 1, wherein the first housing (10) has a transmission section that is designed configured to transfer compressed air.

5. The housing arrangement according to claim 1, wherein the first housing (10) has a transmission section configured to suck in oil.

6. The housing arrangement according to claim 1, wherein the first housing (10) has a transmission section configured as a vent for the first housing (10).

7. The housing arrangement according to claim 1, comprising:
a third housing (30) arranged opposite the second housing (20) relative to the first housing (10) and having a plurality of fastening sections (31) spaced apart from one another in the peripheral direction for fastening to the first housing (10);
wherein:
the second housing (20) is arranged on the first side relative to the first housing (10);
the first housing (10) has on the second side a plurality of second fastening sections (12) spaced apart from each other in the peripheral direction for fastening to the third housing (30); and
the second fastening sections (12) of the first housing (10) and the fastening sections (31) of the third housing (30) are arranged relative to one another such that the first housing (10) can be fastened to the third housing (30) in different angular positions in the peripheral direction.

8. The housing arrangement according to claim 1, wherein the first housing (10) is cylindrical in shape.

9. A drive device (1) comprising:
the housing arrangement according to claim 1;
a first drive motor arranged within the first housing (10);
a manual gearbox arranged within the second housing (20) and comprising the input element which is mechanically operable with the first drive machine; and
an electrical connector (8) which is fastened to a connection section (13) on an outer periphery of the first housing (10) and is designed to supply the first drive motor with electrical power.

10. The drive device (1) according to claim 9, comprising:
a clutch device as part of the drive device (1), the clutch device arranged at least in sections within the third housing (30); and
a second drive motor configured to be mechanically connected to the input element of the manual gearbox via the clutch device.

11. A vehicle with comprising:
the drive device (1) according to claim 9; and
at least one drive element configured to drive the vehicle via the drive device (1).
